(19) United States
(12) Patent Application Publication
(10) Pub. No.: US 2026/0017393 A1
(43) Pub. Date: Jan. 15, 2026

(54) Storage Device for a Mobile User Device, Mobile User Device, and Storage System

(71) Applicant: Bayerische Motoren Werke Aktiengesellschaft, Muenchen (DE)

(72) Inventor: Matthias FINK, Muenchen (DE)

(21) Appl. No.: 19/235,762

(22) Filed: Jun. 12, 2025

(30) Foreign Application Priority Data
Jul. 12, 2024 (DE) 10 2024 119 973.3

(51) Int. Cl. G06F 21/62; B60R 25/24

(52) U.S. Cl. CPC G06F 21/6209; B60R 25/24

(57) ABSTRACT

A storage device for a mobile user device includes a secure storage area and a storage management system configured to manage access to the secure storage area. The storage management system is further configured to reserve a storage section in the secure storage area for key generation information of a digital key for a motor vehicle and to release a part of the reserved storage section in response to a release request.

### CROSS REFERENCE TO RELATED APPLICATION

This application claims priority under 35 U.S.C. § 119 from German Patent Application No. 10 2024 119 973.3, filed Jul. 12, 2024, the entire disclosure of which is herein expressly incorporated by reference.

### BACKGROUND AND SUMMARY

The invention relates to a storage device for a mobile user device, a mobile user device with such a storage device, and a storage system comprising such a storage device or such a mobile user device.

Publication DE 10 2014 203 060 A1, for example, discloses a system for exchanging data between at least one vehicle and at least one mobile device.

The present invention relates to an improved storage device for a mobile user device.

This object is achieved as described in the claimed invention and the description.

A storage device according to embodiments of the invention for a mobile user device comprises a secure storage area and a storage management system which is designed to manage access to the secure storage area. The storage management system is further designed to reserve a storage section in the secure storage area for the key generation information of a digital key for a motor vehicle and to release a part of the reserved storage section in response to a release request.

The storage device according to embodiments of the invention serves in particular to enable secure and at the same time economical handling of data, in particular sensitive data of a motor vehicle, stored on a mobile user device. In particular, the storage device according to embodiments of the invention is used to provide access to data dynamically in a secure and an insecure storage area of a mobile user device for a motor vehicle. A particularly secure storage area is restricted and/or limited and complex to implement. Such a storage device according to embodiments of the invention uses this secure storage area in a dynamic manner.

The storage device and its components, facilities, and/or elements are comprised by or realized on a mobile user device, in particular in both the hardware and the software. In particular, the mobile user device can be a cell phone, for example a smart phone, phablet, and/or tablet, and/or a wearable device, for example a smart watch, Fitbit, and/or smart glasses. The mobile user device is designed separately and is separated and/or remote from the motor vehicle. In particular, the mobile user device has one or more processors and/or operating systems.

For this purpose, the storage device has at least one secure storage area. In particular, the storage device has two storage areas, one of which is designed as a secure storage area and one as an insecure storage area. In particular, the secure storage area is more secure than the insecure storage area. For example, the secure storage area has more security functions and/or security features than the insecure storage area.

Such a security function and/or such a security feature relates, for example, to data confidentiality, data availability, and/or data integrity, which is higher in the secure storage area than in the insecure storage area. In particular, the insecure storage area is not completely insecure but also has certain security functions and/or security features, as will be described later.

The secure storage area can be constructed in a manner logically and/or physically separate from an insecure storage area. For example, the first and second storage areas may be two separate partitions of the same storage system, or two separately constructed storage systems. In particular, the storage system or systems can be designed as non-volatile storage and realized, for example, as NAND and/or flash memory.

The storage device also comprises a storage management system constructed in order to manage access to the secure storage area.

Access includes, for example, read access and/or write access to the secure storage area and/or the insecure storage area. For example, the storage management system receives an access request that includes a read access and/or a write access and executes this access, that is, provides a read access and/or a write access to the respective storage area.

In particular, the storage management system and the secure storage area may together form a secure element and/or be comprised by such a secure element, whereas an insecure storage area is not comprised by the secure element. Such a secure element is a special secure area of the mobile user device that can be hardware-based and/or software-based and that protects the data contained therein or stored therein from attacks and, in particular, manipulation. In particular, an operating system of the mobile user device has no access or only limited access to the secure element, for example through a secure channel, in particular exclusively.

The secure storage area and/or the storage management system can in particular have a separate power supply from an insecure storage area. In particular, the secure element has a power supply that is separate from the remaining components of the mobile user device or self-sufficient.

In the present case, a separate power supply means in particular that operation of the secure storage area and the storage management system is ensured while operation of other components of the mobile user device is suspended, for example because a battery of the mobile user device has a low, in particular critical, state of charge and/or the mobile user device has already been shut down and/or is in a battery-saving mode.

The storage management system is further designed to reserve a storage section in the secure storage area for key generation information of a digital key for a motor vehicle.

For this purpose, the secure storage area has, for example, several storage sections or is divided into several such storage sections, wherein the storage management system manages these several sections and, in particular, access to them. In particular, a certain section of the secure storage is reserved by the storage management system, which in particular has a fixed, further in particular maximum length or size. In particular, the storage section that is reserved for the key generation information is so large that a technically maximally large or long key generation information fits into this storage section or can be stored therein.

A reservation means in particular that this area or section cannot be used for other information and/or data and in particular that no data can or may be written into this section for the duration of the reservation.

Key generation information is information or data on the basis of which a digital key for the vehicle can be generated, in particular for the first time. For example, the key generation information is and/or includes verification, authorization, and/or confirmation that a generated key is correct, genuine, and/or secure. In particular, the key generation information can be provided to the motor vehicle and a digital access key for the motor vehicle can be created or generated there by the motor vehicle, as will be explained further on.

The digital access key is a piece of information, in particular a key pair of an asymmetric and/or hybrid cryptography system, which enables access to the vehicle. In particular, the digital key enables unlocking and/or locking, starting the engine and/or ignition, and/or deactivating an immobilizer, especially using the mobile user device. The digital key can also be referred to as a digital access key and/or access key.

The key generation information is, in particular, generation information for a second or further access key for the motor vehicle, which is generated and/or derived from a first, already existing, valid and/or functioning digital key for the motor vehicle. In particular, the key generation information is previously generated and/or received by a further, second user device which has such a key, as will also be described later.

The storage management system is also designed to release at least part of the storage section previously reserved for the key generation information in response to a release request.

A release request, which can also be referred to as a release notice, release command, and/or release, is a request that signals the storage management system to release part of the reserved storage section. This release request can be generated or derived by the storage management system itself and/or received or provided by a device other than the mobile user device, as will be explained later.

In response to the release of the part of the secure storage, the reservation of the storage section can then be canceled or withdrawn so that this section can then be used for other information and/or data. For example, this released section can then be used for further key generation information, in particular information that can be used to generate a further, second, or third digital key for the motor vehicle or for another motor vehicle. Alternatively or additionally, the released part can also be used for other information and/or data, in particular within the secure element.

The storage device according to embodiments of the invention enables secure and at the same time economical handling of data and, in particular, sensitive data of a motor vehicle that is stored on a mobile user device.

According to one embodiment, the storage management system is further configured to receive the key generation information from a second user device and to release a part of the reserved storage area in response to the key generation information received.

Alternatively, according to an embodiment, the storage management system is further configured to receive the key generation information from a remote computing device and to release a part of the reserved storage area in response to the key generation information received.

In other words, the key generation information can be received either from a second user device or from a remote computing device and, upon receipt, the reserved storage area can be released at the mobile user device. In particular, the key generation information received from the remote computing device may comprise key update information based on which a digital key already present in the secure storage area on the mobile user device is updated. In particular, the key generation information and/or the key update information may have been previously provided by the second user device to the remote computing device and/or may have been generated at the remote computing device.

In particular, the second user device can also be designed as a mobile user device and can, for example, be similar or identical to the first user device described above. In particular, the second user device also comprises a secure storage area, a storage management system, and/or a secure element as described above. In particular, the second user device has a valid digital key for the vehicle.

The remote computing device is different from the mobile user device and is located remotely from it. The remote computing device may in particular be one or more servers, which may be realized at least partially or completely in the cloud. In particular, the remote computing device can be a server farm, for example that of a manufacturer and/or a service provider of the motor vehicle and/or the first and/or second mobile user device and may also be referred to as a backend.

In particular, the key generation information can be received or exchanged between the two user devices or the mobile user device and the remote computing device via one or more wireless communication protocols. Such a wireless communication protocol can, for example, be designed as near-field communication, such as Bluetooth, in particular Bluetooth LE, UWB, NFC, and/or RFID. Alternatively or additionally, the wireless communication protocol can also be designed as far-field communication, such as mobile radio, in particular 3G, 4G, 5G, WiFi or WLAN, and/or Car2X, in particular Car2Infrastructure.

The key generation information received includes the release request. or the receipt of the key generation information causes the generation of the release request, and/or the release request is derived from the key generation information. In response to receiving the key generation information, at least part of the reserved storage area is thus released.

This embodiment makes it possible to manage sensitive data in a particularly dynamic way.

According to one embodiment, the storage management system is further configured to determine a storage size for the received key generation information to release the part of the reserved storage section that exceeds the storage size of the received key generation information.

The storage management system is designed to determine a storage size or length for the key generation information received. In response to this determination, the storage management system is designed to release the part that exceeds the determined storage size. In other words, the storage management system is designed to release the storage space from the reserved storage section that has not been used or occupied by the key generation information.

For example, the entire storage section that is or was reserved for the key generation information could have 64 KB and the actual storage size of the key generation information be only 16 KB. In this case, the part that exceeds the 16 KB, in this case 48 KB, is released.

Determining the storage size causes and/or comprises the release request or the release request or its frame is determined based on and/or derived from the determined storage size.

This embodiment also makes it possible to manage sensitive data in a particularly dynamic way.

According to one embodiment, the storage management system is further designed to provide the key generation information to a motor vehicle and to release a part of the reserved storage section in response to the provision.

The motor vehicle to which the key generation information is provided is, in particular, the motor vehicle for which the digital key is generated or derived from the key generation information.

Provision to the vehicle can also take place via one or more wireless communication protocols, in particular via near-field communication, as described above.

After provision, part of the reserved storage section, in particular the part occupied by the key generation information, can then be released. In particular, based on the determination of the storage size, the excess part of the storage section can be released first and then the remaining part of the storage section can be released, in particular after it has been provided to the vehicle.

A verification, authorization, and/or confirmation that a generated key is correct, genuine, and/or secure can then be carried out on the motor vehicle based on the key generation information and/or a key can be generated on the motor vehicle based on the key generation information.

In particular, in response to the provision of the key generation information, the motor vehicle can send a response, in particular a confirmation of receipt, and further in particular a verification of the generated key back to the mobile user device or provide it to the mobile user device. In response to this provision, part of the reserved storage section can be released.

This embodiment also makes it possible to manage sensitive data in a particularly dynamic way.

According to a further embodiment, the storage management system is further designed to release the entire storage section in response to the provision.

In particular, the storage management system is designed to completely release the storage section in response to the provision of the key generation information to the motor vehicle. In other words, any area of the storage section that was or was previously reserved is released in response to providing the key generation information to the motor vehicle.

Furthermore, in particular, no part or surplus of the storage section has been released beforehand, in particular not in response to the determination of the storage size, but the entire storage section is released exclusively in a single unit after the key generation information has been provided to the motor vehicle, in particular after feedback from the motor vehicle.

This embodiment also makes it possible to manage sensitive data in a particularly dynamic way.

According to a further embodiment, the storage management system is further designed to receive the release request from a remote computing device.

In principle, the remote computing device can be a functionally similar or identical computing device as described above. In particular, it is the same computing device as described above.

In particular, it is possible to communicate with the computing device via one or more wireless communication protocols, in particular using far-field communication as described above.

In particular, the remote computing device may have previously received or been provided with the key generation information from the second user device and/or provided the key generation information to the motor vehicle, also via one or more wireless communication protocols, in particular using far-field communication.

In particular, the remote computing device is designed to receive the key generation information of the digital key for the motor vehicle from the second mobile user device and to provide it to the motor vehicle and, in response, to provide the release request to the mobile user device.

In particular, the remote computing device is provided with a feedback from the motor vehicle, analogous to the previously described embodiment in which the feedback was sent to the first mobile user device, and only thereafter was the release request sent or provided to the first mobile user device.

This embodiment also makes it possible to manage sensitive data in a particularly dynamic way.

According to a further embodiment, the storage management system is further designed to release the entire storage section in response to receiving the release request.

In particular, the storage management system is designed to release the entire memory section in response to receiving the release request. In other words, the entire range of the memory section that was previously reserved or has been reserved is released in response to receiving the release request.

Furthermore, in particular, no part or surplus of the storage section has been released beforehand, in particular not in response to the determination of the storage size, but the entire storage section is released exclusively in a single unit after receipt of the release request, in particular after feedback from the motor vehicle.

This embodiment also makes it possible to manage sensitive data in a particularly dynamic way.

According to a further aspect, a mobile user device comprising a storage device according to one of the previously described embodiments is disclosed. The user device comprises the storage device and its elements or equipment. In addition, the mobile terminal device may also comprise one or more processors that are configured to execute or at least effectuate one of the embodiments described above.

According to a still further aspect, a storage system comprising a remote computing device and a mobile user device and/or a storage device according to one of the previously described embodiments is disclosed.

Optionally, the storage system comprises a second mobile user device and/or a motor vehicle.

The remote computing device is designed to provide key generation information of a digital key for a motor vehicle to the motor vehicle and to provide the release request to the mobile user device in response to the provision of the key generation information to the motor vehicle.

In particular, it is possible to communicate with the computing device via one or more wireless communication protocols, in particular using far-field communication as described above.

The key generation information is the key generation function, in particular the same key generation function for the motor vehicle, for which the storage section is also reserved on the mobile user device, which is then partially released again based on the release request.

The remote computing device is, in particular, the remote computing device described above as well as its functions. In particular, it is possible to communicate with the computing device via one or more wireless communication protocols, in particular using far-field communication as described above.

According to a further embodiment, the remote computing device is further configured to receive the key generation information from a second user device and to provide the key generation information to the motor vehicle in response to receiving the key generation information.

Further features of the invention are shown in the claims, the figure, and the description of the figure. The features and combinations of features mentioned above in the description and the features and combinations of features mentioned below in the description of the figure and/or shown in the figure alone can be used not only in the combination indicated in each case, but also in other combinations or on their own.

The invention will now be explained in more detail with reference to a preferred embodiment and with reference to the drawings.

### BRIEF DESCRIPTION OF THE DRAWING

FIG. 1 a schematic view of a storage device for a mobile user device as well as a storage system.

### DETAILED DESCRIPTION OF THE DRAWING

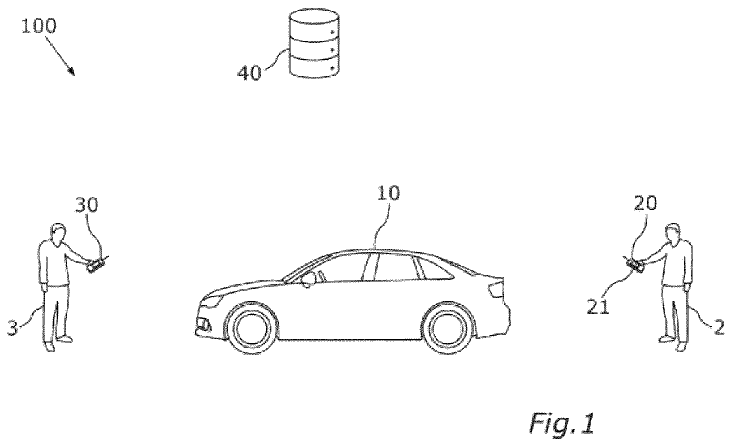

FIG. 1 shows a schematic view of a storage device 21 for a mobile user device 20 and a storage system 100 with a motor vehicle 10.

In this case, the storage device 21 is comprised by the first mobile user device 20 of a first user 2 of the motor vehicle 10 and forms a storage system 100 with a remote computing device 40 and optionally the motor vehicle 10 and/or a second mobile user device 30 of a further user 3 of the motor vehicle 10. The first mobile user device 20 and the second mobile user device 30 are shown here as a smartphone, for example.

The storage device 21 comprises a secure storage area and an insecure storage area, which are not shown in detail here.

The storage device 21 also comprises a storage management system, also not shown, designed to manage access to the secure storage area, wherein the storage management system is further designed to reserve a storage section in the secure storage area for key generation information of a digital key for a motor vehicle 10 and to release a part of the reserved storage section in response to a release request.

The storage management system is further designed to receive the key generation information from the second user device 30 and to release a part of the reserved storage area in response to the received key generation information.

The storage management system is further configured to determine a storage size for the received key generation information and to release that part of the reserved storage section that exceeds the storage size of the received key generation information.

The storage management system is further configured to provide the key generation information to the motor vehicle 10 and to release part of the reserved storage section, in particular the entire storage section, in response to the provision.

The storage management system is further configured to receive the release request from the remote computing device 40 and, in particular, to release the entire storage section in response to receipt of the release request.

The remote computing device 40 is further configured to provide the key generation information of the digital key for the motor vehicle 10 to the motor vehicle 10, and to provide the release request to the mobile user device 20 in response to provision of the key generation information to the motor vehicle 10.

The remote computing device 40 is further configured to receive the key generation information from the second user device 30 and provide the key generation information to the motor vehicle 10 in response to receiving the key generation information.

### Reference List

10 Motor vehicle
2 First user
20 First mobile user device
21 Storage device
3 Second user
30 Second mobile user device
40 Remote computing device
100 Storage system

What is claimed is:

1. A storage device for a mobile user device, the storage device comprising:
a secure storage area; and
a storage management system configured to manage access to the secure storage area, wherein the storage management system is further configured to reserve a storage section in the secure storage area for key generation information of a digital key for a motor vehicle and to release part of the reserved storage section in response to a release request.

2. The storage device according to claim 1, wherein:
the storage management system is further configured to receive the key generation information from a second user device; and
the storage management system is further configured to release part of the reserved storage area in response to the received key generation information.

3. The storage device according to claim 1, wherein:
the storage management system is further configured to receive the key generation information from a remote computing device; and
the storage management system is further configured to release a part of the reserved storage area in response to the received key generation information.

4. The storage device according to claim 2, wherein:
the storage management system is further configured to determine a storage size for the received key generation information; and
the storage management system is further configured to release a part of the reserved storage section which exceeds the storage size of the received key generation information.

5. The storage device according to claim 1, wherein:
the storage management system is further configured to provide the key generation information to a motor vehicle; and
the storage management system is further configured to release part of the reserved storage area in response to the provision.

6. The storage device according to claim 5,
wherein the storage management system is further configured to release the entire storage section in response to the provision.

7. The storage device according to claim 1,
wherein the storage management system is further configured to receive the release request from a remote computing device.

8. The storage device according to claim 7,
wherein the storage management system is further configured to release the entire storage section in response to receipt of the release request.

9. A mobile user device comprising the storage device according to claim 1.

10. A storage system comprising:
the mobile user device according to claim 9; and
a remote computing device; wherein:
the remote computing device is configured to provide the key generation information of the digital key for the motor vehicle to the motor vehicle; and
the remote computing device is further configured to provide the release request to the mobile user device in response to the provision of the key generation information to the motor vehicle.

11. The storage system according to claim 10, wherein:
the remote computing device is further configured to receive the key generation information from a second user device; and
the remote computing device is further configured to provide the key generation information to the motor vehicle in response to receiving the key generation information.
